(19) United States
(12) Patent Application Publication
(10) Pub. No.: US 2010/0273127 A1
(43) Pub. Date: Oct. 28, 2010

(54) PROTECTIVE ASSEMBLY FOR A COMPRESSED GAS INTERPROXIMAL CLEANER

(75) Inventors: Jozef Johannes Maria Janssen, Herten (NL); Bart Gottenbos, Budel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/808,263

(22) PCT Filed: Dec. 9, 2008
(86) PCT No.: PCT/IB2008/055166

§ 371 Date: Jun. 15, 2010

Related U.S. Application Data
(60) Provisional application No. 61/014,493, filed on Dec. 18, 2007.

(51) Int. Cl. A61C 17/02

(52) U.S. Cl. 433/89

(57) ABSTRACT

The protective system includes a nozzle portion (20) of the appliance which has a flange (24) at a proximal end thereof which releasably fits into a body portion (12) of the appliance. A cap member (30, 40) which is secured or securable to the appliance has an opening (32, 50) which is configured relative to the flange such that the nozzle can extend therethrough, but not the flange, so that when the cap member is operatively secured to the appliance, the nozzle is prevented from separating and propelling away from the appliance under the force of compressed gas.

This invention relates generally to interproximal cleaning appliances which use compressed gas, and more specifically concerns an article for preventing a nozzle portion of the appliance from unintentionally separating and coming away from the remainder of the appliance during use thereof.

Interproximal cleaning appliances which incorporate a source of compressed gas typically use the gas to generate a high-speed stream of fluid droplets which are delivered through an extended nozzle portion of the appliance to the selected interproximal areas. If the nozzle is not secured tightly to the remainder of the appliance, there is a chance that the nozzle might be propelled away under the pressure of the compressed gas, causing damage to the user and others and/or property in the vicinity. The lack of a secure connection between the nozzle and the remainder of the appliance may be due to the connection being compromised, such as by wear, or to an unintentional loosening by the user.

It is thus desirable that such an interproximal cleaning appliance be structured or have associated structure to prevent the nozzle from separating from the remainder of the appliance under the force of the compressed gas.

Accordingly, a system for a compressed gas oral cleaning appliance is disclosed, comprising: a nozzle portion of the appliance having a flange at a proximal end thereof for releasably fitting into a body portion of the appliance; and a cap member secured to or securable to the appliance and having an opening which is configured relative to the flange of the nozzle portion to permit the nozzle portion to extend therethrough but not the flange, such that when the cap member is operatively secured to the appliance, the nozzle portion is prevented from separating and propelling away from the appliance under the force of compressed gas.

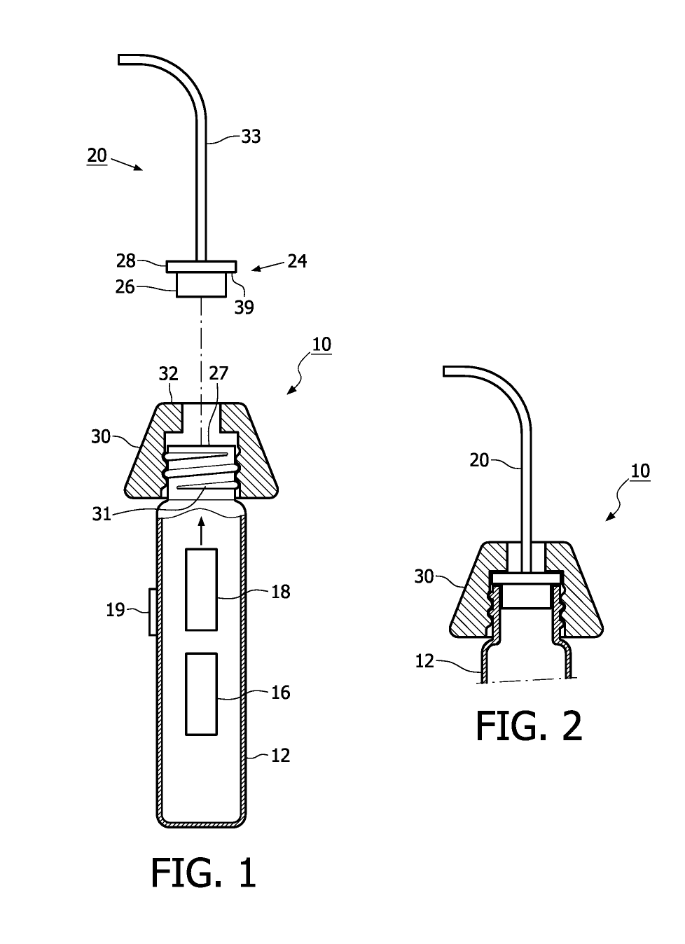

FIGS. 1 and 2 are an exploded and a partially elevational view, respectively, of one embodiment of a system to prevent a nozzle from separating from the remainder of a compressed gas interproximal cleaning appliance.

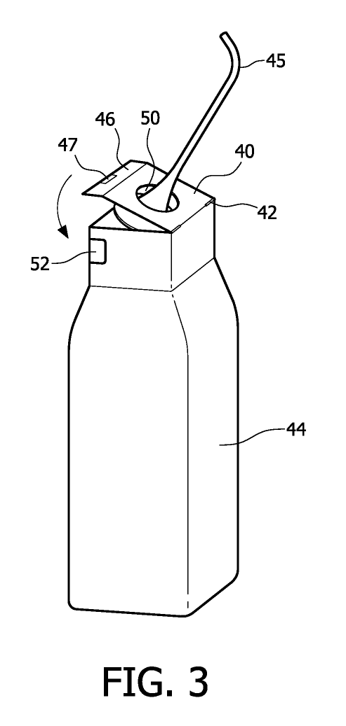

FIG. 3 is a perspective view showing an alternative embodiment to that shown in FIG. 1.

FIGS. 1 and 2 show one embodiment of a nozzle protection assembly. An example of an oral, in particular an interproximal, cleaning appliance using compressed gas is shown generally at 10. In this example, appliance 10 includes a body portion 12 which includes a source of compressed gas 16 and a fluid droplet generator 18. When a control button 19 is operated by a user, a high-speed stream of droplets is produced and directed out of the body portion 12 and through a nozzle assembly 20 to the interproximal area. The compressed gas propels the fluid droplets at a high speed. The appliance 10 can have a variety of configurations and instructions, with a variety of interproximal cleaning devices. The present nozzle protection assembly is useful with those oral care appliances which include a source of compressed gas which presents a risk of the nozzle separating, i.e. propelling, away from the remainder of the appliance at high speed, causing damage to the user or others or property in the vicinity if the nozzle is not properly secured to the body of the appliance.

In the present arrangement, nozzle 20 has a particular configuration, specifically a flange portion 24 at the base (proximal end) of the nozzle. Typically, nozzle 20 will extend outwardly from the flange portion, terminating in a curve, for use in interproximal cleaning, although such a configuration is not necessary. The nozzle 20 may include a guidance tip (not shown) at the distal end thereof to aid in the positioning of the nozzle in the interproximal spaces. The appliance can also be used to clean the front surfaces of the teeth. The flange 24 includes a base portion 26 which mates around its periphery with an exit end 27 of body portion 12, and also includes an adjacent portion 28 which is slightly larger in diameter than base portion 26. The protection assembly further includes a cap member 30 which has an opening 32 at an upper end thereof. Opening 32 is large enough to permit nozzle pipe 33 to extend therethrough, but small enough so that the portion 28 of the flange is larger than the opening, thereby preventing the nozzle from coming out through the cap 30.

In one embodiment, cap 30 takes the form of a truncated cone, the shape of which is designed to match or integrate with body portion 12. Other shapes can, of course, be used as well. Further, while it may be aesthetic that cap member 30 be configured to match the body portion, it is not necessary for proper operation of the cap member. In one embodiment, cap 30 is threaded and mates with a threaded portion 31 at the end of body portion 12. When cap 30 is threaded onto the body portion, nozzle 20 is prevented from propelling away from the body portion, in the event there is not a secure attachment, for whatever reason, between the nozzle and the body portion. In the arrangement shown, flange 24 is configured relative to the cap member and the body portion, such that when the cap member is completely threaded onto body portion 12, flange 24 of the nozzle is firmly seated in the end of the body portion, with a lower surface 39 of the adjacent portion 28 of the flange being seated against the exit end 27 of the body portion. Hence, as long as the cap is threaded onto the body portion, the nozzle is secure relative to the body portion and there is no risk of the nozzle being separated from or flying (propelling) away from the body portion of the appliance.

If desired, an additional security measure could be included by adding a connector, such as a plastic tether, between the cap member and the body of the appliance. The cap member can also include one or more venting holes for release of any accumulated gas in the interior volume of the cap member.

FIG. 3 shows another embodiment of the nozzle protection assembly. This embodiment includes a lid member 40 which is secured by pivot elements 42 such as a hinge, to the distal end of appliance body 44, where nozzle 45 attached to the remainder of the appliance. Lid member 40 is free to rotate about hinge 42, but does not separate completely from the appliance body. Lid member 40 is flat in the embodiment shown and may typically be made from plastic or metal. At an opposing edge of the lid member is a clip 46 which includes a lock element 47 which locks the lid to the appliance body. In this position, the lid member extends across the end of the appliance body, approximately 90° to the axis of the appliance.

When clip 46 is in its locked position, nozzle 45 is securely mated with the body of the appliance. The lid assembly 40 also has an opening 50 which allows the nozzle to extend therethrough, but not a base flange portion thereof, which is like the embodiment of FIG. 1. When the clip is locked, nozzle 45 is prevented from propelling away from the appliance, which might otherwise occur due to the force of the compressed gas. In a modification of FIG. 2, the nozzle 45 could be separately securely engageable with the body portion by a threaded connection or a frictional fit. To remove the nozzle, the clip is released and the lid assembly rotated about hinge 42 to the point where the nozzle can be removed from the lid member. Even if clip 46 comes loose, the lid member 40 will still be attached to the body of the appliance, and will thus still prevent a loose nozzle from being propelled away from the appliance.

In this embodiment, the locking element on the lid assembly could also be configured to engage a valve 52 within the body of the appliance which controls the flow of fluid droplets from the appliance. Unless the valve is engaged by the locking member, the appliance is inoperable.

It should be understood that other arrangements are possible, involving a cap member with an opening through which the nozzle extends, the cap being securely engageable with or attached to the body portion to prevent the nozzle from being propelled away from the remainder of the appliance during operation of the appliance or when the source of compressed gas is operable.

Although a preferred embodiment of the invention has been disclosed for purposes of illustration, it should be understood that various changes, modifications and substitutions may be incorporated in the embodiment without departing from the spirit of the invention which is defined by the claims which follow.

1. A protective system for a compressed gas oral cleaning appliance, comprising:
a nozzle portion (20) of the appliance having a flange (24) at a proximal end thereof for releasably fitting into a body portion (12) of the appliance; and
a cap member (30, 40) secured to or securable to the appliance and having an opening (32, 50) which is configured relative to the flange of the nozzle portion to permit the nozzle portion to extend therethrough but not the flange, such that when the cap member is operatively secured to the appliance, the nozzle portion is prevented from separating and propelling away from the appliance under the force of compressed gas.

2. The protective system of claim 1, wherein the cap member is at least partially removable from the appliance, thus permitting convenient removal or replacement of the nozzle.

3. The protective system of claim 2, wherein the cap member is threadable onto the appliance.

4. The protective system of claim 1, wherein the cap member is configured to be aesthetically compatible with the configuration of the appliance.

5. The protective system of claim 1, wherein the cap member comprises a lid (40) which is secured by a hinge member (42) to one part of the appliance and by a releasable clip (46) to another part of the appliance.

6. The protective system of claim 5, wherein the releasable clip includes a locking element (47) which engages a valve in the appliance to enable operation of the appliance.

7. The protective system of claim 1, wherein the flange includes one portion (26) for fitting into the body portion of the appliance and another larger portion (28) which is configured to prevent the nozzle from separating from the appliance through the opening in the cap member.

8. The protective system of claim 1, wherein the cap member includes venting holes for release of any accumulated gas in the interior volume of the cap member.

9. The protective system of claim 1, wherein the cleaning appliance is an interproximal cleaning appliance.

10. A compressed gas oral cleaning appliance with a protective system comprising:
a compressed gas oral cleaning appliance (10) for producing a stream of fluid droplets for cleaning teeth, including the interproximal area, the appliance including a nozzle portion (20) having a flange (24) at a proximal end thereof for releasably fitting into a body portion (12) of the appliance; and
a cap member (30, 40) secured to or securable to the appliance and having an opening (32, 50) which is configured relative to the flange of the nozzle portion to permit the nozzle portion to extend therethrough but not the flange, such that when the cap member is operatively secured to the appliance, the nozzle portion is prevented from separating and propelling away from the appliance under the force of compressed gas.

11. The protective system of claim 10, wherein the cap member is at least partially removable from the appliance, thus permitting convenient removal or replacement of the nozzle.
